(19) United States
(12) Patent Application Publication
(10) Pub. No.: US 2022/0138881 A1
(43) Pub. Date: May 5, 2022

(54) SYSTEMS AND METHODS FOR SKILL DEVELOPMENT MONITORING AND FEEDBACK

(71) Applicant: Pearson Education, Inc., Bloomington, MN (US)

(72) Inventors: Peter SABATINI, Maywood, NJ (US); Jodi McPHERSON, Bloomington, MN (US); Andrew PINCKNEY, Bloomington, MN (US); Scott DUSTAN, Bloomington, MN (US); Samuel DOWNS, Bloomington, MN (US); Sara Bakken, Webster, TX (US); John SADAUSKAS, Phoenix, AZ (US); Heather L. RESER, Englewood, CO (US); David ARENDS, Bloomington, MN (US); Michael CASKEY, Bloomington, MN (US); Matthew HOFFBERG, Bloomington, MN (US); Benjamin ROGERS, Bloomington, MN (US); Norman LEVESQUE, Bloomington, MN (US)

(21) Appl. No.: 17/520,341

(22) Filed: Nov. 5, 2021

Related U.S. Application Data
(60) Provisional application No. 63/110,102, filed on Nov. 5, 2020.

(51) Int. Cl. G06Q 50/20

(52) U.S. Cl. CPC G06Q 50/2057; G06F 40/279

(57) ABSTRACT

A system and method are presented. User metadata defining a set of activities undertaken by a user are received by a processor. The processor determines, based on the set of activities, a skill history for the user. The skill history identifies a first plurality of skills associated with the user. The processor determines a preferred career associated with the user, determines, for the preferred career and by accessing a career skill repository, a second plurality of skills associated with the preferred career, determines a missing skill by comparing the first plurality of skills associated with the user to the second plurality of skills associated with the preferred career to identify the missing skill that is in the second plurality of skills and not in the first plurality of skills and outputs a user interface identifying the missing skill.

### CROSS-REFERENCE TO RELATED APPLICATION(S)

This application claims the benefit of priority from provisional application No. 63/110,102, filed under the same title [or title] on Nov. 5, 2020, the entire contents of which is incorporated herein by reference.

### FIELD

This disclosure relates to the field of systems and methods configured to assist a user in identifying and monitoring developments in the user's skill set and articulating a description of the same to third parties.

### BACKGROUND

As individuals enter the job market it can be Important to demonstrate aptitude and capability at general skills that are important in the workplace, such as conflict resolution, leadership, or critical thinking, along with experience and expertise in conventional school subjects. It can, however, be difficult for a student to articulate what skills they have acquired, how they have developed such skills, by merely listing courses or classes taken and grade achieved. These skills may not usually be the subject of formal courses and are often learned organically without specific instruction or delineation that the skill is being developed by the individual. In many cases, individuals may not understand what skills (i.e. critical thinking, leadership, etc.) they have developed and how they gained those skills. Therefore, the individuals may not understand how to provide examples of their experience demonstrating these skills. This may be important in cases where the individual is applying for a job or to enter a post-graduate program.

Additionally, individuals may not be able to easily evaluate what general skills they have acquired, or to determine what skills are important to their chosen professions and career goals. Conversely, it may be difficult for students to evaluate what professions or careers correlate with the skills that they have already acquired.

Consequently, a system to assist individuals in identifying and documenting growth in skill experience, and for evaluating how these skills apply to specific careers or professions, is desirable. Such identification may assist the user in gathering as much skill-related data as possible with as little burden as possible in an automated fashion. Once the skill data has been accumulated, it is also desirable to present such information back to the user in a manner to assist in retelling the story of their respective skill growth. Additionally, it is desirable provide an analysis of how the skills of the individual apply to specific professions or career goals, and to make such skill data accessible, on a permission basis, to third parties enabling such third parties to retrieve and analyze skill history data associated with an individual. The systems describe herein address these and other issues.

### SUMMARY

In one aspect, the present disclosure provides a method including the steps of receiving, by a processor, user metadata defining a set of activities undertaken by a user; determining, based on the set of activities, a skill history for the user, the skill history identify a first plurality of skills associated with the user; determining, by the processor, a preferred career associated with the user; determining, for the preferred career and by accessing a career skill repository, a second plurality of skills associated with the preferred career; determining a missing skill by comparing the first plurality of skills associated with the user to the second plurality of skills associated with the preferred career to identify the missing skill that is in the second plurality of skills and not in the first plurality of skills; and outputting, by the processor, a user interface identifying the missing skill.

The method may further comprise identifying, by the processor, a second career; determining, for the second career and by accessing the career skill repository, a third plurality of skills associated with the preferred career; and including, in the user interface, a description of the second career when a difference between the third plurality of skills and first plurality of skills is less than a threshold.

The method may further comprise comparing the first plurality of skills to the third plurality of skills by: converting the first plurality of skills into a first vector value; converting the third plurality of skills into a second vector value; and determining an angular difference between the first vector value and the second vector value.

The step of determining a skill history may comprise mapping activities to skills by analyzing data using natural language processing, and/or mapping activities to skills by applying natural language processing to text associated with an activity. The step of determining a skill history may also comprises outputting a user interface that includes a text entry window configured to receive a description of an activity or experience; receiving a text entry; and applying at least one of natural language processing or machine learning to map the text entry to the second plurality of skills.

The step of generating an output may also comprise identifying activities to improve the first plurality of skills associated with the user and/or providing a display correlating a skill with a graphical depiction of the user's mastery of the skill and/or displaying a progress timeline of the second plurality of skills.

In another aspect, the present disclosure provides a system for skill development monitoring and feedback comprising: a data store comprising at least one database storing a user profile database and a database storing a career skill repository; and a processor in communication with the data store and at least one display. The processor is programmed to retrieve user metadata defining a set of activities undertaken by a user from the user profile database; determine, based on the set of activities, a skill history for the user, the skill history identifying a first plurality of skills associated with the user; determine a preferred career associated for the user; accessing the career skill repository, and determining a second plurality of skills associated with the preferred career; determine a missing skill by comparing the first plurality of skills associated with the user to the second plurality of skills associated with the preferred career to identify the missing skill that is in the second plurality of skills and not in the first plurality of skills; and output a user interface on the display identifying the missing skill.

The processor may further be programmed to: identify a second career; determine, for the second career and by accessing the career skill repository, a third plurality of skills associated with the preferred career; and include, in the user interface, a description of the second career when a difference between the third plurality of skills and first plurality of skills is less than a predetermined threshold.

The processor may further be programmed to compare the first plurality of skills to the third plurality of skills by: converting the first plurality of skills into a first vector value; converting the third plurality of skills into a second vector value; and determining an angular difference between the first vector value and the second vector value.

The processor may further be programmed to map activities to skills by analyzing data using natural language processing and/or map activities to skills by applying natural language processing to text associated with an activity.

The processor may further be programed to identify activities to improve the first plurality of skills associated with the user and output the identified skills. The processor may also be programmed to determine a skill history by outputting a user interface that includes a text entry window configured to receive a description of an activity or experience; receive a text entry; and apply at least one of natural language processing or machine learning to map the text entry to the second plurality of skills.

The system processor may further be programmed to generate a display correlating a skill with a graphical depiction of the user's mastery of the skill and/or to display a progress timeline of the second plurality of skills.

In still another aspect, the present disclosure provides a system for automatically generating a career path for a user, producing a portfolio of skills corresponding to the career path, and sharing the portfolio. The system comprises a data store; a display; a user interface; a network providing access to external resources for career data and data sharing services; and a processor in communication with the data store, the user interface, the network, and the display. The processor programmed to: receive data through the user input device defining a career goal of a user; analyze the received data defining the career goal to determine at least one career option for the user; identify at least one resource providing data about the user for accomplishing the at least one career option, and accessing the at least one resource through the network; receive data about the user through the network identifying at least one skill applicable to the career goal and store the data in a user portfolio database; and provide access for the user to share at least a portion of the user portfolio database through the network. The processor may also be programmed to import data corresponding to the user through the network and map the data to identified skills.

The above features of the present disclosure will be better understood from the following detailed description taken in conjunction with the accompanying drawings.

### BRIEF DESCRIPTION OF THE DRAWINGS

FIG. 1 illustrates a system level block diagram showing data stores, data centers, servers, and clients of a distributed computing environment, in accordance with various embodiments.

FIG. 2 illustrates a system level block diagram showing physical and logical components of a special-purpose computer device within a distributed computing environment, in accordance with various embodiments.

FIG. 3A illustrates a system by which a user's skill experience can be accumulated and displayed for review and edit by the user or retrieval and/or transmission to third parties.

FIG. 3B illustrates various data stores that may be included in data store servers of FIG. 3A, in accordance with various embodiments.

FIG. 4 illustrates a process flow for a method of accumulating and processing a user's skill data.

FIG. 5A depicts a user interfaces that may be generated by the present system to facilitate skill data accumulation for a user and the display of the same in a time line or summary format.

FIG. 5B depicts a user interface that may be generated by the present system to display a menu of skills for a user.

FIG. 5C depicts a user interface that may be generated by the present system to provide information about a skill to a user.

FIG. 5D depicts a user interface that may be generated by the present system to provide information about subskills within a skill category to a user.

FIG. 5E depicts a user interface that may be generated by the present system for the user to provide a description of the activity or experience that led to development of a specific skill.

FIG. 5F depicts the user interface of FIG. 5E as data is input by the user.

FIG. 5G depicts a user interface that provides confirmation of entry of the information of FIG. 5F and prompts a user to continue adding skill information.

FIG. 5H depicts a user interface that may be generated by the present system to illustrate skill development process and to provide possible career pathways.

FIG. 5I depicts a user interface illustrating skill development progress for the user.

FIG. 5J depicts a user interface that presents a report to a user to display growth in a set of skills.

FIG. 5K depicts a user interface that presents a report to a user to detail how a skill was developed.

FIG. 5L depicts a user interface that enables a user to describe activities undertaken to develop particular sets of skills.

FIG. 5M depicts a user interface that enables a user to describe activities undertaken to develop particular sets of skills.

FIG. 5N depicts a user interface that provides a report displaying attributes of a particular skill developed by the user.

FIG. 6 depicts a flow diagram representing an embodiment of skills development monitoring and feedback.

FIG. 7 depicts multiple user profiles within an embodiment of a system for skills development monitoring and feedback.

FIG. 8 depicts a first user profile within an embodiment of a system for skills development monitoring and feedback.

FIG. 9 depicts a second user profile within an embodiment of a system for skills development monitoring and feedback.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

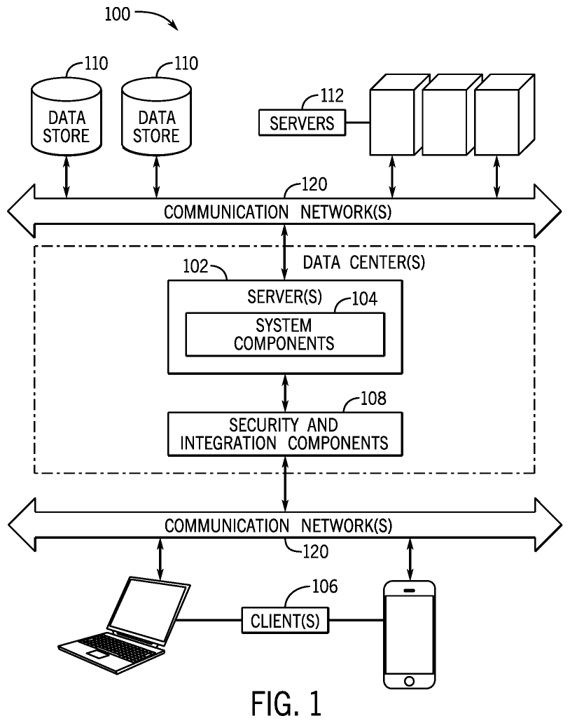

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

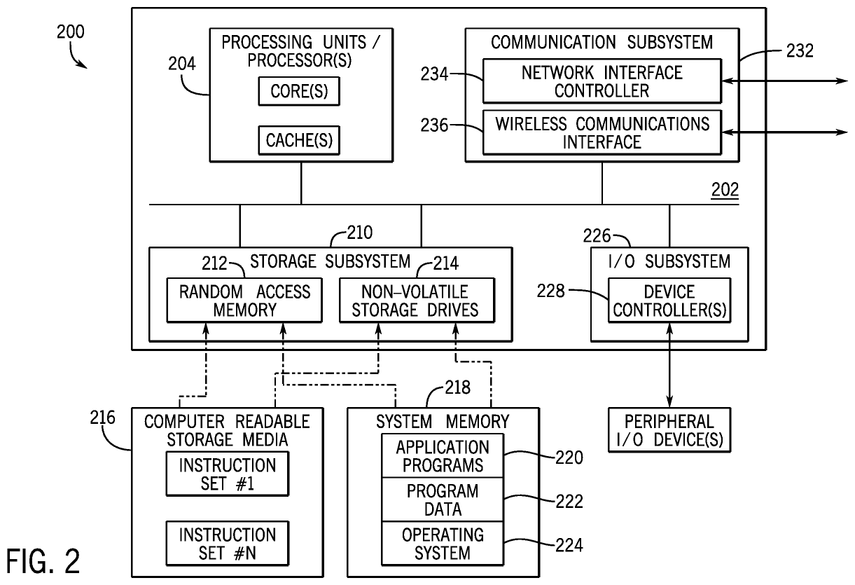

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

The disclosed system can assist individuals, such as students, assess, develop, and track skill sets, including personal and social capabilities. The system may be used, for example, by universities' career services, student success, and other divisions to help students connect the personal and social capabilities that they learn through the completion of coursework and extra-curricular activities with their future academic and career success. In many cases, students may be able to use the system to demonstrate mastery of personal and social capabilities to potential employers.

The present system may be implemented as part of an experiential digital learning system to assist users in identifying the personal and social capability skills they have (i.e. leadership, critical thinking, communication, etc.), what efforts the users undertook to develop and hone those skills, how to articulate these skills, the skills the users still need to gain for the job that they would like to have (i.e. finding the skills gaps), and what jobs may suit the users' particular skill set.

The system may assist the individual in collecting data about the user via the activities that a user participates in (i.e. sports, newspaper, clubs, classes, etc.). The activities in which the user has participated may be retrieved from a computer system (e.g., an organization or school-based computer server) that stores historical records of activities or groups with which the user has participated. Those activities (or groups) can then be automatically associated with particular sets of skills. For example, activities such as sporting activities may be previously-associated with skills such as leadership and conflict resolution. Once the user's activities have been correlated to a particular set of skills, those skills may be stored in a historical record and associated with the user. Once a historical skill listing has been created for the user, the user may be prompted to update and/or edit the historical skill listing that was automatically generated by the system. The user may edit the listed skills to make corrections, add specific details, or elaborate on the skill experience that is included in the user's historical skill record.

The system can then create a historical record of the user's skill history showing progress to particular levels of experience and/or expertise for different skills.

The user can, for example, specify a desired career or profession. In cases where the user is a student, for example, the student may use the system to search for and identify a desired career or profession. Within the system, the available careers and professions may be previously-associated with their own sets of skills. And in some cases, particular careers may be associated with skill sets having particular designated levels of experience or expertise in certain skills. For example, careers in engineering may be associated with relatively high levels of critical thinking skills and less elevated levels of leadership skills. Careers in politics may require relatively high levels of leadership skills.

Having selected a desired career or profession (or multiples of the same) the system can compare the skills associated with the selected career profession to the skills (and skill levels) that have been achieved by the user. In this manner, the system may identify skill gaps (e.g., skills associated with the career profession that are not present in the individual's skill history) and so can make recommendations to the user as to skills to develop for the user's desired career or profession and/or specific activities that the user may undertake to develop skills that require development.

Conversely, rather than require the user to specify a particular desired career or profession, the system may analyze the user's skill history to identify careers or professions that are themselves associated with skill sets that most closely match those that have been developed by the user.

Therefore, using the present system, an undergraduate student may discover that the skills they are developing in higher education would make them well suited for a particular career. The student can then explore that career and can decide to continue building skills to be well prepared for that career. Similarly, an undergraduate student may be preparing for a job interview and may use the present system to review their skill history and reflections to be well equipped to tell a story about how they developed their skills.

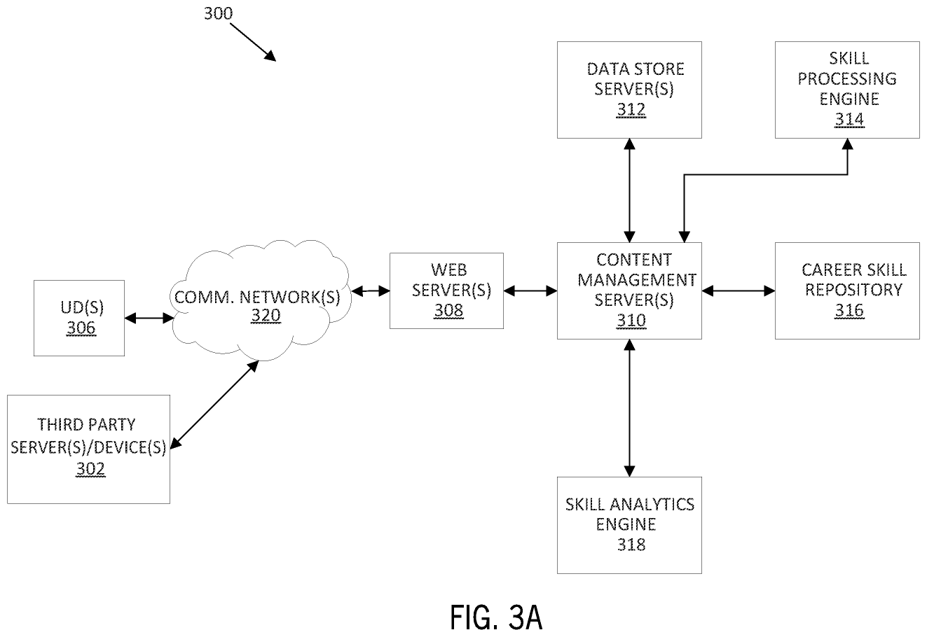

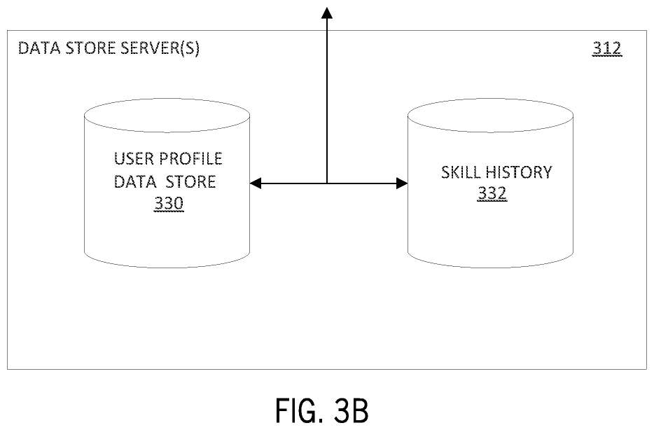

Referring now to FIG. 3A, an illustrative block diagram of a system 300 that may process skill experience and make career suggestions in accordance with the present disclosure is shown. The system 300 may include computing systems including processors, which may be provided in one or more web servers 308, content management servers 310, data store servers 312, skill processing engines 314, career skill repository 316, and skill analytics engine 318, as shown. Such components of system 300 may be implemented by executing computer-readable instructions with one or more processors of one or more servers of the system 300, which may form part of the content management servers 310, or other servers that are separate from the content management servers (not shown; e.g., servers 112, FIG. 1).

The web servers 308 (e.g., which correspond to at least a subset of the servers 102, 112 of FIG. 1), by way of example, may be communicatively coupled to one or more user devices (UDs) 306, and third party servers 302 via one or more communication networks 320 (e.g., network 120 of FIG. 1). For example, the web servers 308 may include hyper-text transfer protocol (HTTP)) servers, web application programming interface (API) servers, and the like. For example, the web servers 308 may handle incoming and outgoing network traffic, may pass incoming data to the resource management servers 310, and may pass outgoing data to the communication network 320 to be routed to a destination UD 306 or third party server 302.

For example, the web servers 308 may provide cross-domain and/or cross-platform web services in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the web servers 308 and user devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption.

The content management servers 310 (e.g., servers 102, FIG. 1; system 200, FIG. 2) may include any applicable type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 310 may include one or more server farms, clusters, or any other appropriate arrangement and/or combination of computer servers. Content management server 310 may act according to stored instructions (e.g., in the form of source code, object code, executable code) located in a memory subsystem of the content management server 310, and may run an operating system, including any commercially available server operating system and/or any other operating systems discussed herein. The content management servers 310 may provide instructions to and receive information from the other devices within the system 300, in order to manage and transmit content resources, user data, and server or client applications executing within the system 300.

The data store server(s) 312 (e.g., servers 112 including data stores 110 of FIG. 1) may be communicatively coupled to the content management servers 310. Turning to FIG. 3B, a diagram is shown, illustrating different data stores 330-332 that may be included in the data store server(s) 312. As shown, the data store servers 312 may include a user profile data store 330 and a skill history data store 332.

The paragraphs below describe examples of specific data stores that may be implemented within some embodiments of the system 300. It should be understood that the below descriptions of data stores 330-332, including their functionality and types of data stored therein, are illustrative and non-limiting. Data stores server architecture, design, and the execution of specific data stores 330-332 may depend on the context, size, and functional requirements of the system 300. For example, in professional training and educational applications, separate databases or file-based storage systems may be implemented in data store server(s) 312 to store trainee and/or student data, trainer and/or professor data, training module data and content descriptions, training results, evaluation data, and the like. In applications involving media distribution from content providers to subscribers, separate data stores may be implemented in data stores server(s) 312 to store listings of available content titles and descriptions, content title usage statistics, subscriber profiles, account data, payment data, network usage statistics, etc.

Referring now to FIG. 3B, the user profile database 330 can include user metadata relating to a user's status, location, or the like. This information can identify, for example, a device a user is using, the location of that device, or the like. In some embodiments, this information can be generated based on location detection technology including, for example, a navigation system, global positioning system, or the like. The user profile database 330 can include user metadata identifying communication information associated with users identified in the user profile database 330. This information can, for example, identify one or several devices used or controlled by the users, user telephone numbers, user email addresses, communication preferences, or the like.

Information relating to the user's status can identify, for example, logged-in status information that can indicate whether the user is presently logged-in to the system 300 and/or whether the log-in is active. In some embodiments, the information relating to the user's status can identify whether the user is currently accessing content and/or participating in an activity from the content distribution network 330.

In some embodiments, information relating to the user's status can identify, for example, one or several attributes of the user's interaction with the system 300, and/or content distributed by the system 300. This can include data identifying the user's interactions with the system 300, the content consumed by the user through the system 300, or the like. In some embodiments, this can include data identifying the type of information accessed through the system 300 and/or the type of activity performed by the user via the system 300, the lapsed time since the last time the user accessed content and/or participated in an activity from the system 300, or the like. In some embodiments, this information can relate to a content program (e.g., course) comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities.

The user profile database 330 may store data describing a preferred profession or career that has been designated by the user. The profession or career data may be designated by the user having performed a search or available professions or careers. Alternatively, the preferred profession or career may have been selected by the user from a list of suggestions provided in a suitable user interface by the present system.

The skill history database 332 may store information describing the user's academic and/or educational history and activities undertaken by the user. For example, the information may identify one or several courses of study that the user has initiated, completed, and/or partially completed, as well as grades received in those courses of study. The dates on which the various courses of study were completed may also be stored in the skill history database 332. In some embodiments, the student's academic and/or educational history can further include information identifying student performance on one or several tests, quizzes, and/or assignments.

The skill history database 332 also stores a listing of historical skills that have been achieved by the user. The skills may be associated with the user, the date on which the skill was achieved, as well as descriptive information describing the activity that was completed in order for the user to have achieved the designated skill. The skill history database 332 may store descriptions of the activity that resulted in a particular skill being achieved. The description may be a predetermined narrative associated with the activity and/or skill, or may be entered and/or edited by the users themselves. Other descriptive information such as related data files, images, or other multimedia may also be stored in the skill history database 332 to better describe the activities completed by users in achieving particular skills.

The user profile database 330 can include user metadata identifying one or several skills and, optionally, corresponding user skill levels possessed by users. In some embodiments, such user skill levels can identify a user's proficiency in a given skill based on the user's past performance in interacting with the system 300. User skill levels can, for example, identify a predicted skill level determined based on the user's past performance in interacting with the system 300 (e.g., by processing features characterizing the user's past performance or other applicable characteristics of the user with one or several predictive models, such as machine learning models). Skills possessed by the user may also be determined based on the user's responses to one or more baseline assessments (e.g., designed to assess general skill proficiency or specific skill levels), as will be explained. Additionally, a third party (e.g., the user's supervisor or manager) may endorse the user as possessing a general or specific level of proficiency in one or more skills. Skills associated with a user in the user profile database 330 may further be defined via self-report by the user, which may be helpful when identifying skills that are not easily quantifiable.

Returning to FIG. 3A, the skill processing engine 314 analyzes historical activities of the user to determine a set of skills that have been achieved or undertaken by the user. Skill processing engine 314, with permission of the user, may retrieve historical activities undertaken by the user from a remote data source, such as a school or university data system (e.g., via communication networks 320). The historical data may be a listing of courses taken by the user and a listing of other activities undertaken by the user. For example, the school may store records identifying non-academic courses taken by the individual (e.g., a rock-climbing course or a dancing course) and other activities in which the user participated. For example, the user may have signed up to participate in sporting or other team activities (e.g., a co-ed volleyball or soccer team), competitions hosted by the school (e.g., a hackathon event for programming), food drive or other volunteer operations, internships with particular sponsoring companies, and the like.

Skill processing engine 314 also stores a mapping, for each potential activity that may be present with a user's historical records, that associates each activity with a particular set of skills that may be associated with the activity. For example, conventional coursework, such as a computer programming courses, may be mapped to skills such as critical thinking, logical reasoning, excel mastery, and the like. Other types of non-course related activities may be associated with similar or different sets of activities. For example, a volunteer activity may be associated with leadership skills and teamwork development skills.

Using the mapping, skill processing engine 314 determines, the associated skills for each of the historical activities that were identified for the user. The skill processing engine 314 can then generate a historical record depicting how the user has developed new skills over time. If the user participated in multiple activities that were each associated with developing the same or similar skills, the skill processing engine 314 may reflect that by determining that the user has advanced or improved their skill level for that particular skill.

The skill processing engine 314 may also evaluate skill development without relying on an explicit mapping of activity to associated skills. For example, the skill processing engine 318 may perform an analysis of a description associated with a particular activity undertaken by the user to determine skills that may have been developed or improved by participation in the activity to map activities to skills. This may involve natural language processing (NLP) of the text associated with the description of the activity, or more advanced approaches using machine learning (ML) to analyze data (e.g., textual descriptions, images and/or multimedia) associated with a particular activity to determine the skills that were honed or improved by participation in the activity.

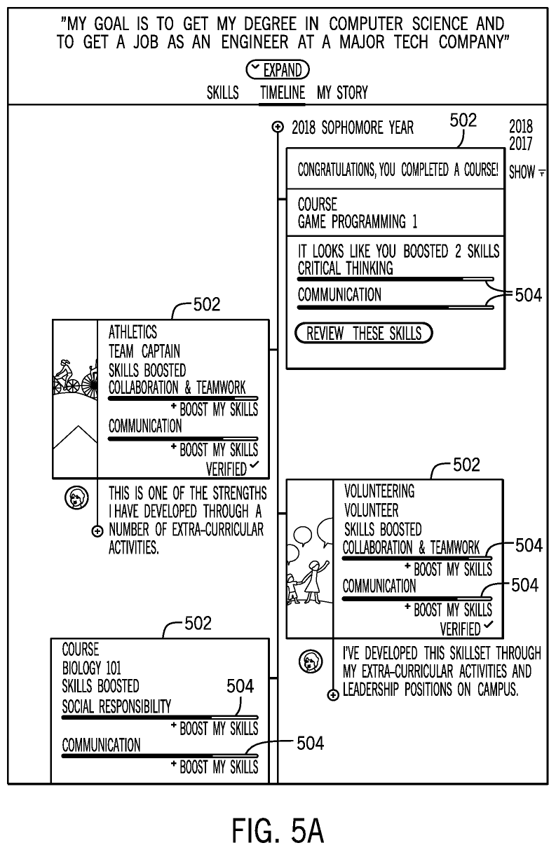

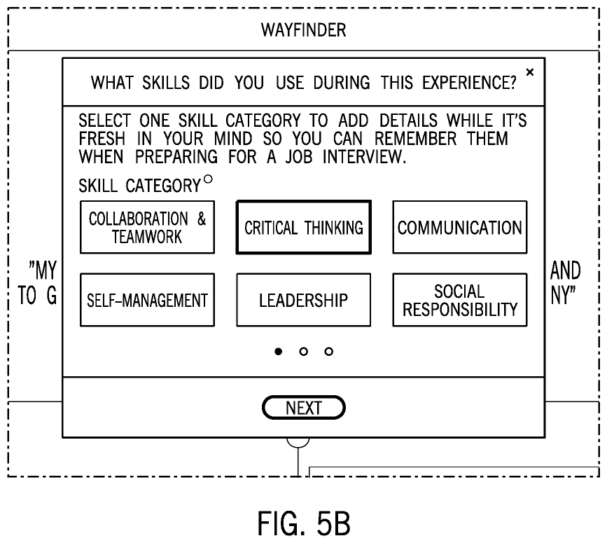

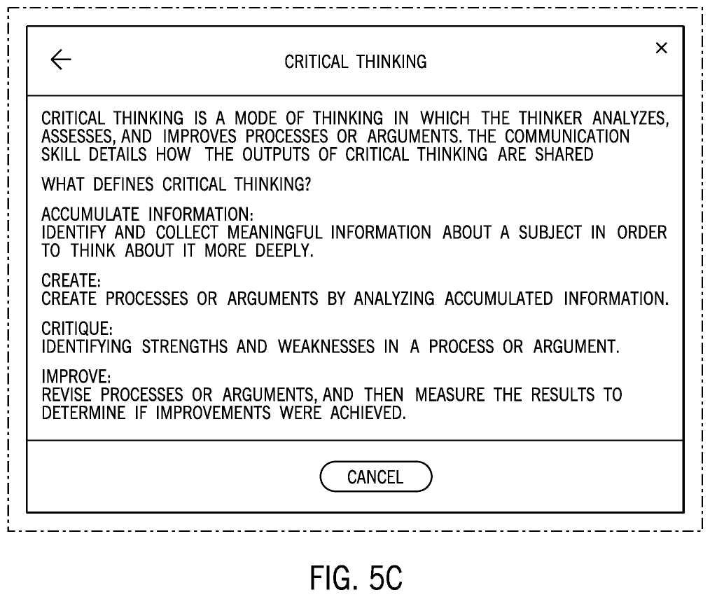

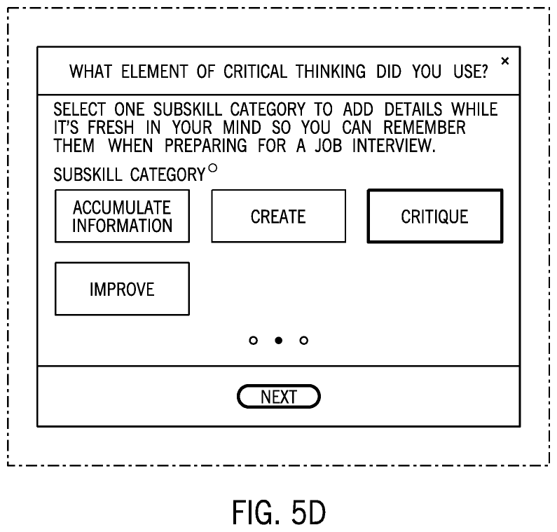

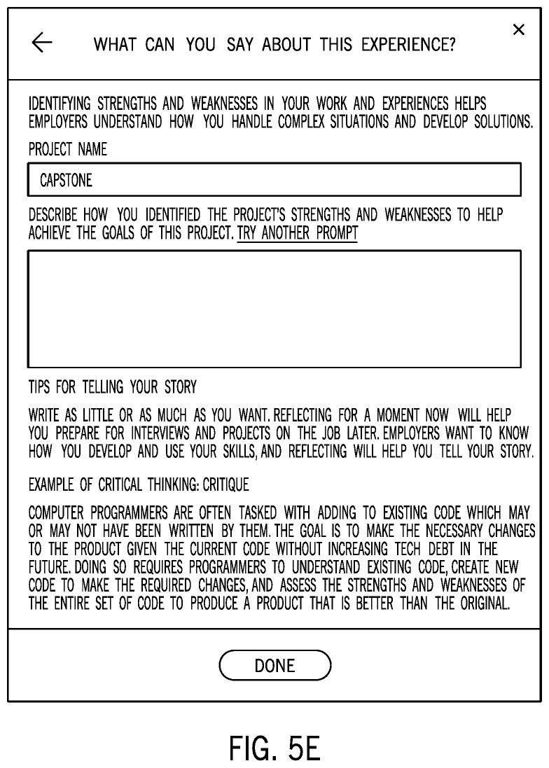

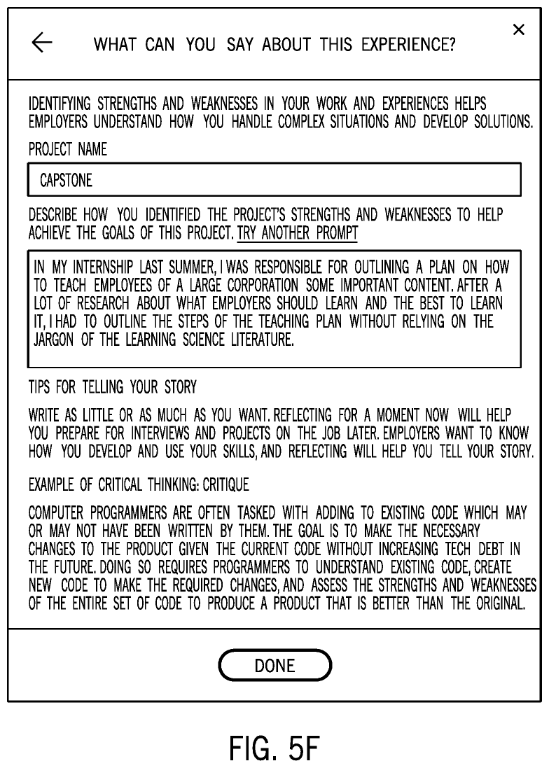

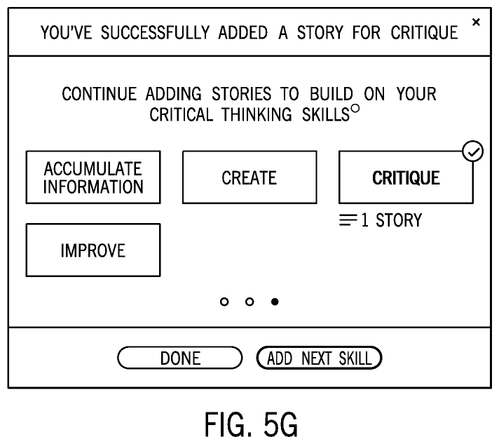

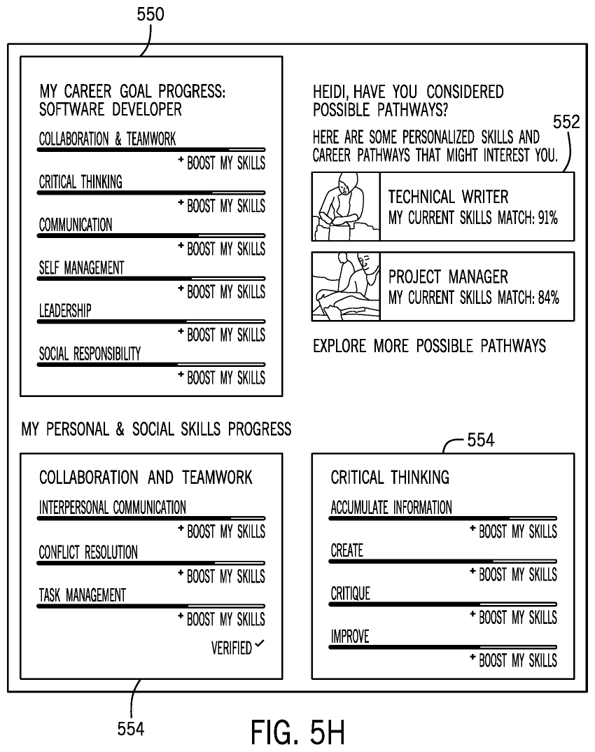

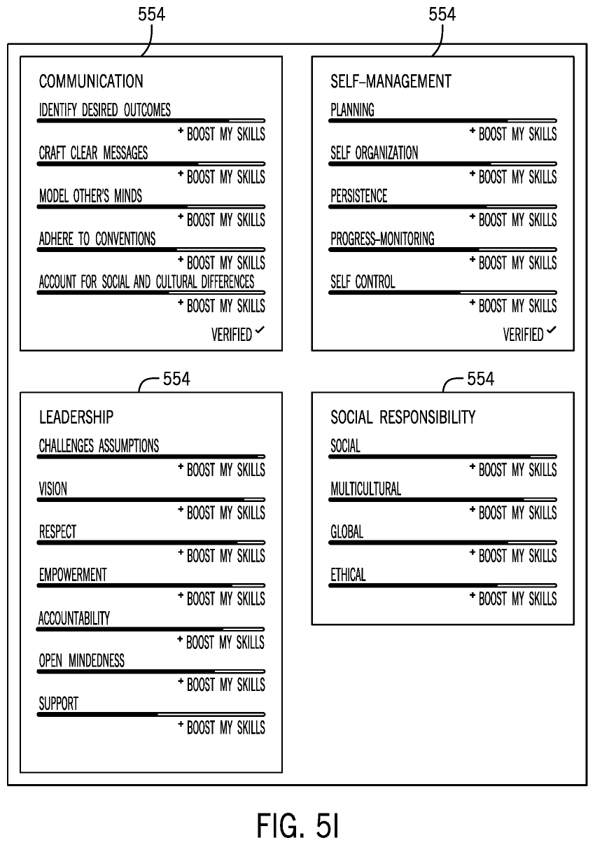

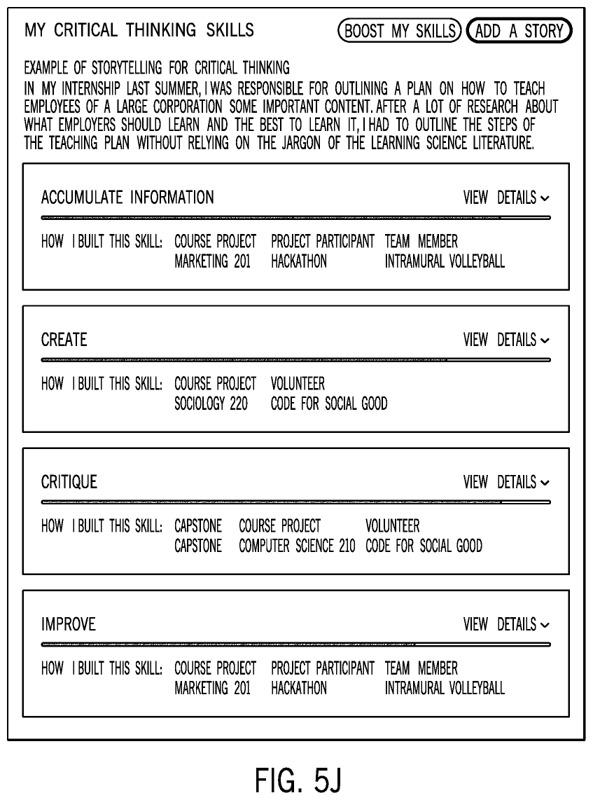

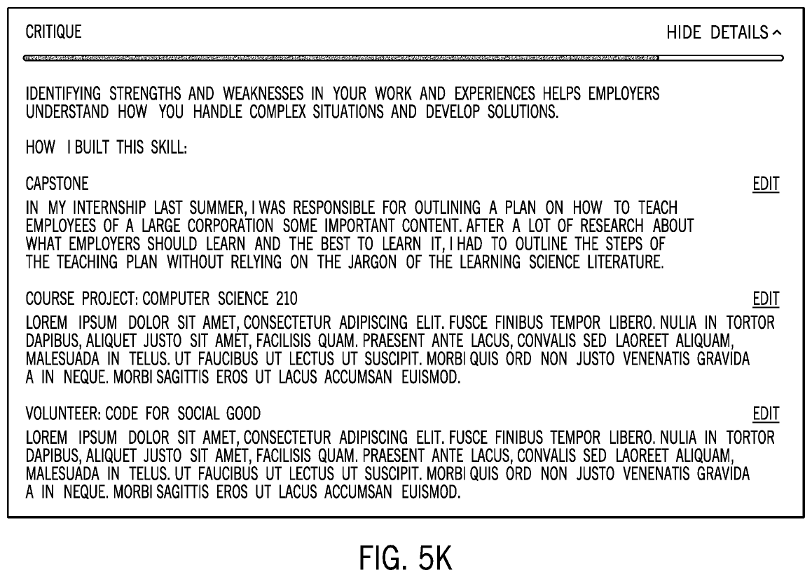

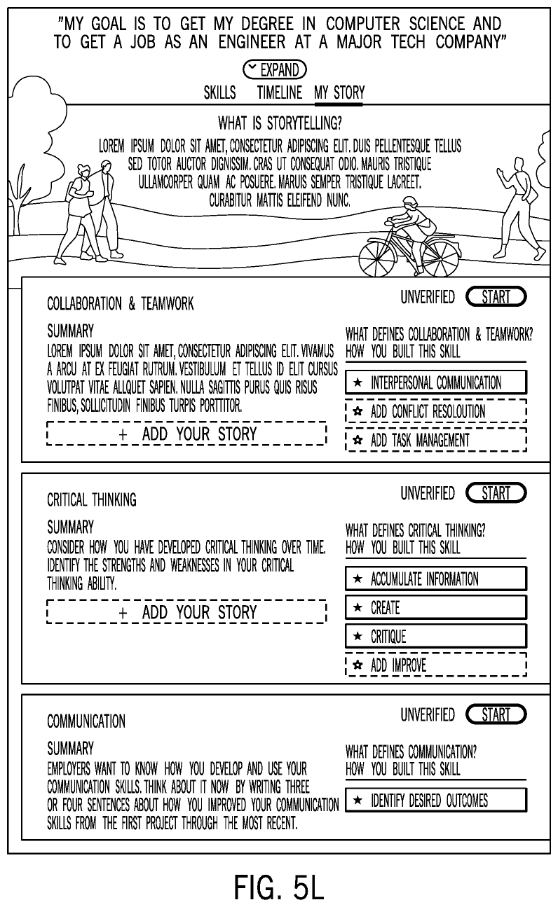

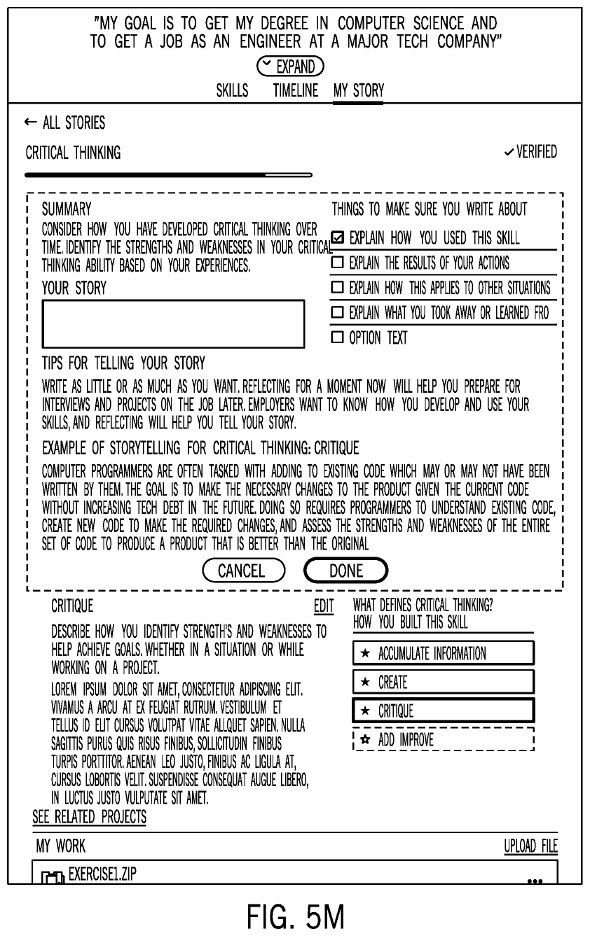

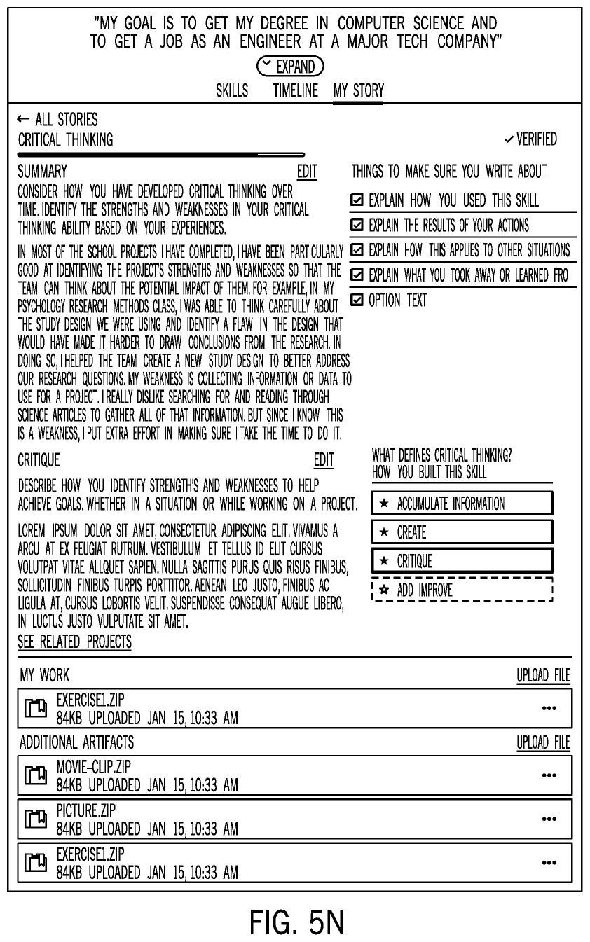

Skill processing engine 314 may generate a number of reports illustrating the skill sets that has been cultivated by a particular user and how those skills have grown over time. The report may be transmitted to content management server 310 that can, in turn, host the report on web server 308 for review (and potential editing) by a user using user device 306. Alternatively, a user may give permission to a third party (e.g., a potential employer or recruiter) to access their own skill history report using a third party device 302. Example skill history reports for a particular user are illustrated in various aspects of FIGS. 5A-5N.

The skill processing engine 314 may also analyze a student's assessment results to provide evaluation of whether the user has developed a particular skill, and the user's corresponding skill level. For example, the skill processor may retrieve an evaluation from an evaluation data store 334 for an assessment taken by a user, and evaluate the assessment. The skill processing engine 314 may determine the skill level of the user in the skill via this analysis. In some cases, an assessment engine may deliver one or more baseline assessments to the user to determine the respective skill level of a user with respect to one or more skills. For baseline assessments, the “grade” determined by the assessment engine may be translated into an estimated skill level of the user for a given skill. In addition to identifying a user's skill proficiency or skill level, these baseline assessments may also identify whether a user possesses a given skill or set of skills at all.

The career skill repository 316 stores a listing of careers and/or professions that a particular user of system 300 may wish to pursue. The listing of careers and professions may include conventional careers and/or professions (e.g., teach, engineer, doctor), specific professions (e.g., machine learning engine programmer, multimedia journalist, oncologist), or more general categories of career and/or profession (e.g., civic leader, counselor, maker). For each career or profession contained within the career skill repository, the career skill repository 316 identifies a set of skills that are associated with the particular skill or career. The set of skills may identify particular skills, preferred (or required) levels for those skills, and a description of the career or professions and the skills themselves.

The skill analytics engine 318 is configured to analyze the skills of a particular user (e.g., retrieved from the skill history database 332 for that user) and compare the user's set of skills to the sets of skills associated with different careers or professions in the career skill repository database 316 to identify skill gaps. Using this analysis, the skill analytics engine 318 can make suggestions of both skills that a particular user may develop to meet the skills sets associated with a particular desired career or profession. Or, alternatively, the skill analytics engine 318 may determine careers or professions associated with sets of skills that match (or largely coincide with) the skill set of a particular user so that those careers or professions may be recommended to that user. For example, the skill analytics engine may analyze the skills of a particular user, compare to the skills associated with a stored profession or career, and identify one or more profession or career to a user when the difference between the skills of the user and those of a profession are within a predetermined threshold.

For example, if a career or profession for which a particular user aspires is associated with in career skill repository 316 (and so requires) a set of skills A, B, and C, the skill analytics engine 318 may recommend activities to the user that are themselves associated with skills A, B, and C. As an initial step, the skill analytics engine 318 may analyze the user's skill history to verify the user's proficiency in skill A, in skill B, and in skill C. As will be described, a set of skill recommendations may be established for the user (e.g., by the skill analytics engine 318) identifying skills that the user should acquire or develop in order to better qualify for their goal career or profession.

For example, the skill analytics engine 318 may retrieve data for a user from the user profile data store 330 and skill history database 332, and may analyze this data to generate a skill path for the user. For example, the skill analytics engine 318 may identify the user's goal career and/or profession, may identify a skill gap between the user's skills and/or skill levels and the skills and/or skill levels required to achieve the user's goal. Based on that skill gap, the skill analytics engine 318 can make suggestions to close the gap and/or identify alternative careers and/or professions that may be more aligned with the user's skillset.

Any of the third party servers 302, the UDs 306, the front-end servers 308, the content management servers 310, the data store servers 312, the skill processing engines 314, the career skill repository 316, and the skill analytics engines 318 may be implemented by computer systems similar to the system 200 of FIG. 2.

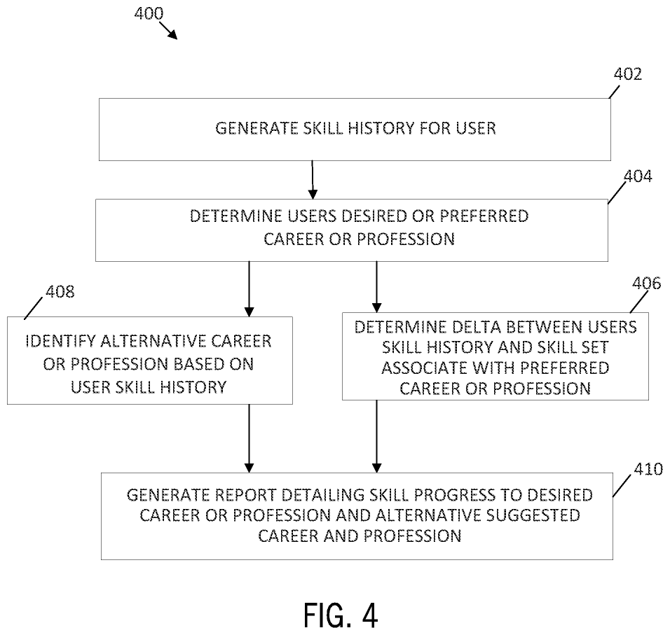

FIG. 4 shows an illustrative process flow of a method 400 by which, based on an analysis of the skills of a user, the user can be provided with a summary of the user's existing skills and recommendations of skills to develop (e.g., via a listing of specific skills to develop or activities to undertake that are associated with particular skills to develop) to meet particular goals. The method 400 may, for example be performed via the execution of computer-readable instructions via one or more computer processors (e.g., processors 204 of FIG. 2), which may be included in one or more computer servers (e.g., servers 102, 112, 308, 310, 312, FIGS. 1, 3A; device 200, FIG. 2) in communication with one or more data stores (e.g., data stores 110, 330, 332, FIG. 3B). The steps of the method 400 are described as being performed using one such processor, though it should be understood that multiple processors may be used. Examples of how the steps of the method 400 can be applied are provided in the context of FIGS. 3A and 3B and corresponding reference numerals are therefore used.

At step 402, a processor (e.g., a processor implementing skill processing engine 314) analyzes a historical record of activities of a user to determine a skill history for the user. As described above with respect to the skill processing engine 314, this may involve retrieving from a historical records of an educational facility activities completed or undertaken by the user and associated descriptions of the activities. The activities can then be mapped, either explicitly or through analysis, via NLP or ML, of the descriptive content, to particular skills. In some embodiments, the analysis performed in step 402 will associate a particular activity or group of activities not just with a particular skill but also a proficiency level for that skill for the user.

At step 404, the processor determines (e.g., via accessing user profile data store 330) a preferred career or profession for the user (or several of the same). At step 408 the processor (e.g., via skill processing engine 314) analyzes the skills associated with a set of careers and professions (e.g., retrieved from career skill repository 316) to identify careers and professions associated with sets of skills that most closely matches the skill set associated with the user and determined in step 402.

Step 408 may, for example, be performed by vector analysis. Here, the skills associated with the user (as determined in step 402) may be converted into a vector where each dimension in the vector is associated with a particular skill and a magnitude of the vector in each dimension is associated with the user's skill level for that skill. Similarly, the skills associated with the careers and/or professions in career skill repository 316 may be converted into multidimensional arrays of the same dimensions. The careers or professions having arrays that are most closely aligned with the user's skill vector may then be determined to be careers or skills that are most closely suited to the existing skill set of the user. The processor may also determine which skills associated with those careers or professions differ from the skills of the user and generate recommendations (e.g., either skills to develop or activities associated with those skills) for the user to undertake to develop skills so that the user's skill set more closely matches those associated with the career or profession.

Similarly, in step 406 the processor performs a comparison and determines skills that are missing from the user's skill set (e.g., determined in step 402) that are present in the career or profession that the user has previously indicated as a desired career or profession. Once determined, the list of missing skills can be displayed to the user and activities or suggestions can be made to assist the user in developing or improving those missing skills.

In step 410, the processor generates an output report for the user. The report may detail the user's current skill set and skill levels for each of the listed skills. Based on the output of step 408, the report may also provide an indication of careers or professions requiring skills that are relatively well matched to those of the user. Similarly, based on the output of step 406, the output report may identify for the user skills that require additional development or improvement to match the skills associated with the user's desired career or profession. Accordingly the system may provide suggestions about activities the user can undertake to improve the user's chances at succeeding in the desired career or profession.

FIGS. 5A-5N depict screenshots showing example user interfaces that may be generated by the present system (e.g., system 300 of FIG. 3A) in accordance steps of method 400 of FIG. 4 and with the present disclosure.

FIG. 5A depicts a skill history reports that may be generated by the system in accordance with step 402 of the method of FIG. 4. The report includes a summary of activities 502 undertaken by the user. Under each activity 502, the report summarizes skills 504 that were user developed as part of the activity. Each skill is associated with a virtual indicator (e.g., a bar, gauge, color code, score, etc.) that reflects the user's level with each particular skill. As depicted, the various activities 502 and skills 504 may be arranged on a timeline enabling the user to see their progression in developing new skills.

The activities and skills depicted in the user interface of FIG. 5A may be generated, for example, by skill processing engine 314 automatically (e.g., based upon historical records of a user's activity that are retrieved from an educational facilities database). Alternatively, the activities and skills may be added by a user manually (or the activities and skills that are automatically generated may be edited by a user).

FIGS. 5B-5G depicts a series of user interfaces that may be generated by the system to enable a user to add a new activity to their skill history (or, alternatively, the user interfaces may enable a user to edit an existing activity). FIG. 5B depicts a selection screen allowing the user to select a particular skill (or collection of skills) that were developed as part of a new activity or experience that was undertaken by the user. The user interface of FIG. 5C may be displayed for the user to provide more information describing a particular skill that was selected by the user in the user interface of FIG. 5B. This enables the user to more accurately describe the skill that was developed. After selecting a first skill in the user interface of FIG. 5B, the user may again use the interface depicted in FIG. 5D to select additional skills that may have been developed as part of a particular activity. With a set of skills selected, in the user interface of FIG. 5E, the user can provide a description of the activity or experience that led to the development of the skills that were selected in the user interfaces of FIGS. 5B and 5D. The form of FIG. 5E is shown completed in the screenshot of FIG. 5F. After the user has described the activity, the user clicks the ‘Done’ button in the user interface and, as shown in FIG. 5G, the system generates a confirmation user interface letting the user know that the description of the activity and its associated skills has been saved into the user's skill history (e.g., stored in skill history database 332).

As discussed above, with the user's skill history loaded into the system (e.g., either automatically or using the manual addition/edit process illustrated in FIGS. 5B-5G), the system can, in accordance with the method of FIG. 4 generate a report, as shown in FIGS. 5H and 5I, that both recommends potential careers and/or professions 552 requiring skill sets that match most closely with those of the user. The interface can also provide summaries 554 of the users current skills growth and progression of the same.

For each skill accumulated by the user, the system can generate a report indicating growth of various skills that relate to a particular higher-level skill top. FIG. 5J, for example, is a report that may be generated by the system display growth in a set of skills that all relate to the general skill of critical thinking. Then, by selecting one of the skills of the user interface of FIG. 5J, the system can provide more information describing attributes of that particular selected skill. FIG. 5K, for example, is a report detailing information describing how the user has developed their ‘critique’ skill. The information display could be generated automatically, or may be edited or created by the user directly, as described herein.

FIGS. 5L and 5M depict an alternative user interface enabling a user to describe activities undertaken to develop particular sets of skills. The interfaces enable a narrative to be associated with a particular skills (either entered/edited by the user or created automatically) as well as sets of files (e.g., that contain multimedia or written records) that may be associated with the skill development. FIG. 5N depicts a further alternative report that may be generated by the system to display attributes of a particular skill developed by the user.

Using the various user interfaces and reports of FIGS. 5A-5N, therefore, a user can review their current skill set status, review detailed information describing how those skills were developed, and the activities undertaken to develop those skills. The user can then be better suited to share their current skill status and experience in developing skills with third parties, such as recruiters or potential employees. In some cases, the users may also enable certain third parties (e.g., recruiters or potential employees) to directly access all or portions of their skill development history and associated reports.

The disclosed system provides unique ways to present a skill history, a skill repository, and/or a skill mapping of what learners have done and what they can do. While the user's skill history, skill mapping, and skill collection as disclosed herein are important elements, the embodiments disclosed below provide improvements in the current state of the art by providing innovative ways to use this data to provide users with a centralized software used to help learners determine a career path that is best for them, and utilize an aggregated skill history to identify a specific career trajectory for each user.

The disclosed embodiments provide a market opportunity, wherein users (e.g., graduating students who want to find a first job, people that want to re-enter the job market, and the like) are able to determine a career pathway, and to better understand how to execute the career pathway in order to achieve their career goals.

The disclosed system may provide users with the academic or career equivalent of a location and/or mapping software. For example, an effective map application allows a user to determine a single destination, determine the user's current location, and determine the pathways available to the user to reach the destination. The map application may then analyze the two locations, and generate multiple alternative routes for the user to reach the destination. Some map applications may allow a user to avoid highways or construction, and the like.

The disclosed embodiments use a similar concept within a career pathways application to determine an ideal career destination for a user, wherein the user is presented with the most effective pathway to complete their career goals, while avoiding unnecessary paths (e.g., avoiding higher education in order to take an alternative career route), and connecting the user to the resources needed to achieve their career goals. Effectively, from a career pathways perspective, the disclosed embodiments provide an easy method for a user to understand who they are, where they want to go, and then help connect them with the resources they need to create a plan to get there. The system can, for example, provide a graphical user interface that allows a user to access a search engine for searching information about themselves and a desired career; storage, allowing the user to retain potential careers for exploration, and to keep track of career achievements, or follow careers of others; an explore engine, enabling a user to explore similar professions or careers; data, including, for example, videos for researching careers or professions, and analyses of the “temperature” of specific careers (e.g. which careers are heating up or cooling off); data storage of career information, including videos; a sharing engine, allowing a user to share data with family, peers, or advisors to receive guidance and advice; and a directions engine, personalizing a path for each individual user, as described below.

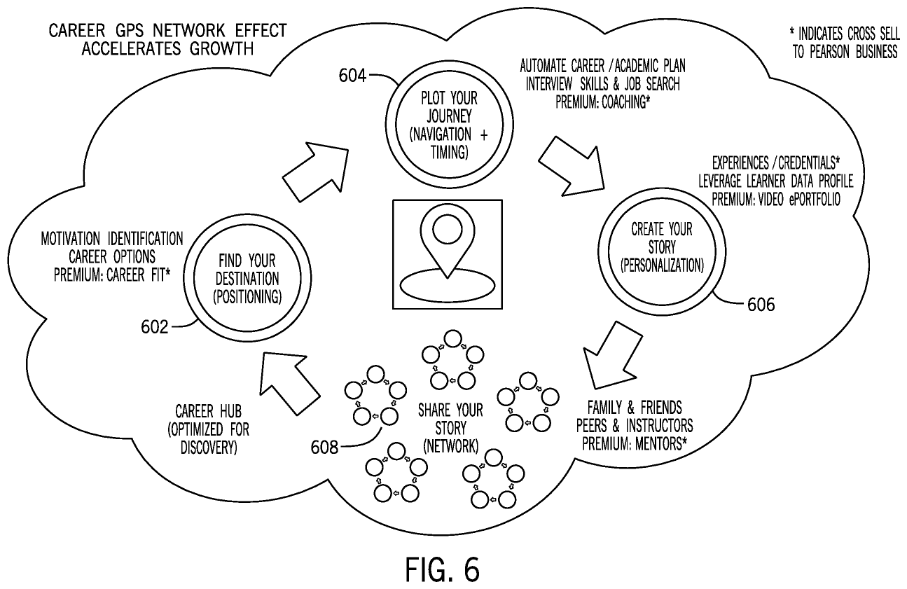

Referring now to FIG. 6, to provide the functions described above, the disclosed system may provide a “career GPS,” a system that provides instructions and pathways for the user to accomplish their career goals.

The disclosed system may include one or more software modules executed within memory by one or more processors on one or more server or client devices. These software modules may be configured to center a user's focus on a user experience personalized to the user, which specifically fits the user's career goals. To accomplish this, the disclosed system may execute specific software module, identifying any missing components and executing the appropriate software modules for these components, then providing a series of steps (i.e., a career roadmap), which specifically spells out the steps the user needs to take to accomplish their career goals.

Referring still to FIG. 6, a first step executed by the disclosed system in automatically generating a recommended career path for the user is to receive input from the user (step 602). Data may be provided, for example, via a graphical user interface (GUI) on a user client device 106, configured to receive user input defining the user's current status and the user's career goals. As a non-limiting example, the disclosed system may generate a GUI including a series of questions for the user to determine their occupational identity and the user's interests and motivations.

The disclosed system, such as a processor that may be associated with server 112, may receive the data from the client device, analyze the received data, and automatically determine the best career options, match, and fit for the user. To accomplish this, the disclosed system may compare the user data against career data stored in database 110, and further investigate and analyze the data to select a career that matches the data input by the user to identify one or more career goals for the user.

Once the user's career goals have been identified, the user may plot and begin their career journey (step 604). To accomplish this, the disclosed system may identify and access one or more additional career services software modules within an employability ecosystem to connect to the resources for the identified career, and to accomplish the identified career goals. One example of a suitable employability ecosystem is Pearson PATHWAYS, produced by Pearson plc, 80 Strand, London, England WC2R 0RL.

It should be noted that this step should not be confused with the additional career software modules themselves, but instead provide recommendations for how to use these additional software modules to accomplish the user's career goals. The disclosed embodiments may therefore be considered an electronic pipeline, allowing users to access these additional software resources, as a parallel process, in order to recommend career navigation to the user. The disclosed embodiments may therefore be a tool to drive traffic to these other software modules and systems, and may likewise receive network traffic from these additional software and modules.

Using the disclosed system, as well as this additional software modules, the user may access these resources, and begin to identify previously mastered skills, as well as skills that are developed through the career path recommended by the disclosed system and additional software modules. As these skills are identified and input into the system, the disclosed system may store this data in association with the user, and begin to identify potential career paths that the user is qualified for, in order to make further recommendations or prepare the user for their future career.

To accomplish this, the disclosed system may aggregate the user's experiences, skills, credentials, courses taken, and the like into a user portfolio, which may be stored in association with the user in database 110. The disclosed system may then use the data in this stored user portfolio, identify one or more courses or projects flagged in the database by the user, and automatically build a plurality of user content that may act as a narrative, allowing the user to copy and paste, or export, this data to share in the user's job acquisition journey (step 606).

It should be noted that this narrative is not designed to replace social media outlets for such data (e.g., LinkedIn) or a user resume, Instead, this narrative may comprise a complimentary resource for the user to apply in an interview process. For example, this portfolio and narrative may be used in a second interview to distinguish the user from other similarly qualified candidates, by highlighting and demonstrating applications of skills specific to the user. In these situations, the user may access and display their portfolio to a potential employer.

The final step of the flywheel illustrated in FIG. 6 is therefore sharing the user's story, utilizing the disclosed system (step 608). For example, by utilizing the user portfolio, the user may share their interests, their understanding, their skills, their career goals, and the roadmap for completing these goals. The user may then share this information with trusted parties such as family, friends, professional colleagues, teachers, professors, guidance counselors, and the like, within a trusted network, to determine, from their feedback, the effectiveness of their presentation and whether it will resonate with the audience. The people within the user's network may then provide feedback, allowing the user to update and refine their presentation for use in their employment search.

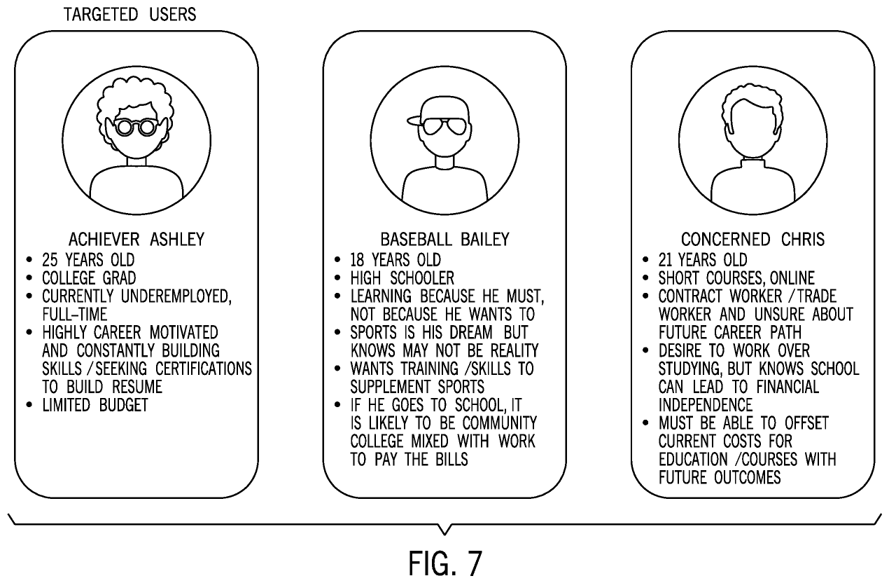

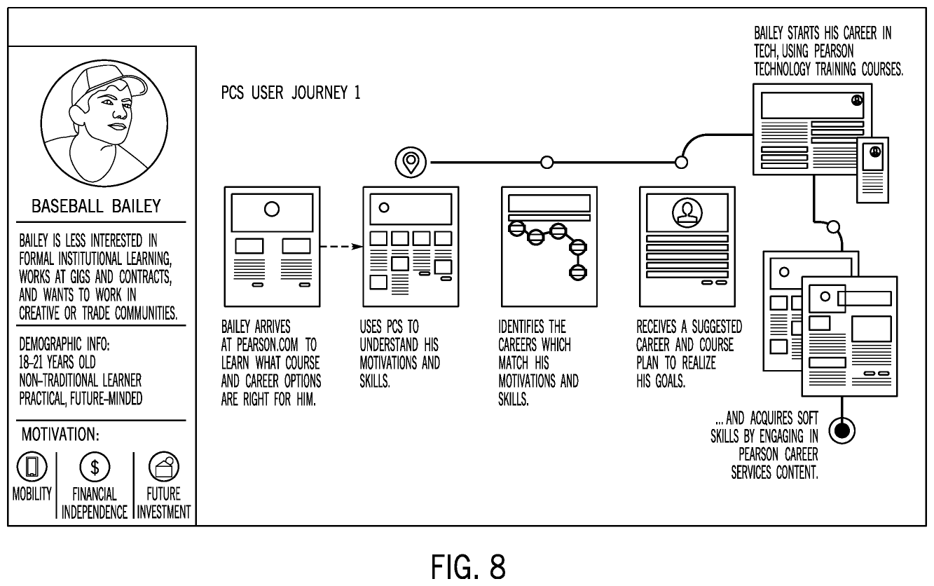

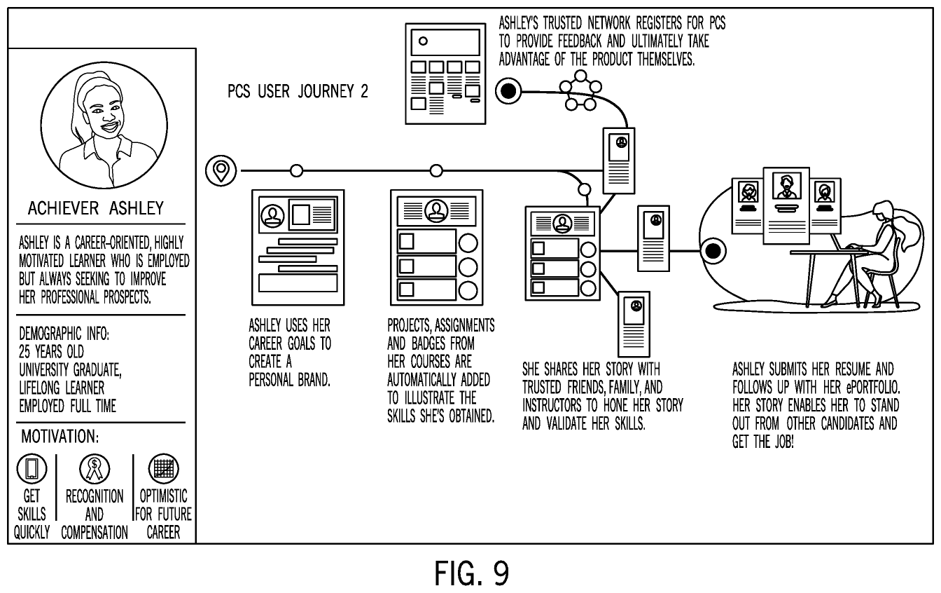

FIG. 7 represents a high level overview of three user profiles automatically generated using the disclosed system. FIGS. 8 and 9 represent more detailed versions of two of these portfolios. For example, FIG. 9 demonstrates the generated user portfolio for an example user, Bailey. In this example, Bailey's career ambition is to be a professional baseball player. Using the disclosed system, Bailey may log into the system using his previously generated credentials, and provide user input through his client device responding to a user assessment to understand what motivates him, what inspires him, what companies are a good match for him, and ultimately what careers are a good match in his career path.

The system may use this data to automatically generate a user profile highlighting his interests and skills, and Bailey may determine from this analysis that he would really be interested in getting into IT. On recommendations automatically generated from the user profile, Bailey may then access one or more additional software packages or modules, or other products (e.g., recommending specific courses or academic programs) or certifications that he will need and are available in order to move his career in IT forward, as well as one or more software packages, modules, or products allowing him to also acquire some of the soft or professional skills available through the disclosed system (e.g. Pearson Career Success, or PCS). By utilizing these resources and recommendations to achieve the needed skills, Bailey may move forward in his IT career.

FIG. 9 demonstrates the generated user portfolio for a similar, but separate, example user, Ashley. Ashley is very different from Bailey, in that she is in higher education and is very career oriented, and is very much aware of her career goals. As such, Ashley may access the disclosed system, become authenticated, and use her client device to input her career goals into the disclosed system. In addition to her input data, the disclosed system may identify and import the data from the institutions she's attended, the courses she has taken, projects and assignment she has completed, and the like. The system may automatically aggregate this data, and generate the portfolio seen in FIG. 9 from the aggregated data. Ashley may then request, and the disclosed system may automatically generate from the aggregated data and the electronic portfolio, a plurality of content that she can then share with her network of trusted family, friends, colleagues, etc. Ashley may then input data to update and improve this portfolio and content, which she may then use as a narrative in job interviews and the like.

In some embodiments, the disclosed system may work with additional software modules, packages, and products, as noted above. For example, the disclosed embodiments may work with higher education courseware to map the skills acquired by a learner or user, and using the aggregated data, may flag certain courses or projects, and import those into the disclosed system, which may be added to the aggregated data. In some embodiments, the disclosed system may analyze data imported from certain universities, and identifying skills associated with certain courses, so that the skills are mapped to the courses in order to create a more comprehensive profile for the user, which may be added to the user content to expand the narrative available to the user. In some embodiments, skills, credential, experience, or additional similar data may be imported into the disclosed system.

Other configurations and uses of the above disclosure will be apparent to those having ordinary skill in the art upon consideration of the specification and practice of methods and systems disclosed herein. The specification and examples given should be considered exemplary only, and it is contemplated that the appended claims will cover any other such embodiments or modifications as fall within the true scope of the disclosure. For example, although specific hardware configurations have been described, it will be apparent that hardware configurations can be varied and that various types of processing devices, computers, servers, communication networks and memory components can be used. Additionally, although specific ordering of steps are described in some cases, the order of steps can in other cases be varied. Although specific terms like software module are used herein, the configuration of the software is not restricted to any specific module or configuration.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method comprising:
receiving, by a processor, user metadata defining a set of activities undertaken by a user;
determining, based on the set of activities, a skill history for the user, the skill history identify a first plurality of skills associated with the user;
determining, by the processor, a preferred career associated with the user;
determining, for the preferred career and by accessing a career skill repository, a second plurality of skills associated with the preferred career;
determining a missing skill by comparing the first plurality of skills associated with the user to the second plurality of skills associated with the preferred career to identify the missing skill that is in the second plurality of skills and not in the first plurality of skills; and
outputting, by the processor, a user interface identifying the missing skill.

2. The method of claim 1, further comprising:
identifying, by the processor, a second career;
determining, for the second career and by accessing the career skill repository, a third plurality of skills associated with the preferred career; and
including, in the user interface, a description of the second career when a difference between the third plurality of skills and first plurality of skills is less than a threshold.

3. The method of claim 2, further comprising comparing the first plurality of skills to the third plurality of skills by:
converting the first plurality of skills into a first vector value;
converting the third plurality of skills into a second vector value; and
determining an angular difference between the first vector value and the second vector value.

4. The method of claim 1, wherein the step of determining a skill history comprises mapping activities to skills by analyzing data using natural language processing.

5. The method of claim 1, wherein the step of determining a skill history comprises mapping activities to skills by applying natural language processing to text associated with an activity.

6. The method of claim 1, wherein the step of generating an output comprises identifying activities to improve the first plurality of skills associated with the user.

7. The method of claim 1, wherein the step of generating an output comprises providing a display correlating a skill with a graphical depiction of the user's mastery of the skill.

8. The method of claim 1, wherein the step of determining a skill history comprises:
outputting a user interface that includes a text entry window configured to receive a description of an activity or experience;
receiving a text entry; and
applying at least one of natural language processing or machine learning to map the text entry to the second plurality of skills.

9. The method of claim 1, wherein the step of generating an output comprises displaying a progress timeline of the second plurality of skills.

10. A system for skill development monitoring and feedback comprising:
a data store comprising at least one database storing a user profile database and a database storing a career skill repository;
a processor in communication with the data store and at least one display, the processor programmed to:
retrieve user metadata defining a set of activities undertaken by a user from the user profile database;
determine, based on the set of activities, a skill history for the user, the skill history identifying a first plurality of skills associated with the user;
determine a preferred career associated for the user;
accessing the career skill repository, and determining a second plurality of skills associated with the preferred career;
determine a missing skill by comparing the first plurality of skills associated with the user to the second plurality of skills associated with the preferred career to identify the missing skill that is in the second plurality of skills and not in the first plurality of skills; and
outputting a user interface on the display identifying the missing skill.

11. The system of claim 1, wherein the processor is further programmed to:
identify a second career;
determine, for the second career and by accessing the career skill repository, a third plurality of skills associated with the preferred career; and
include, in the user interface, a description of the second career when a difference between the third plurality of skills and first plurality of skills is less than a predetermined threshold.

12. The system of claim 11, wherein the processor is further programmed to compare the first plurality of skills to the third plurality of skills by:
converting the first plurality of skills into a first vector value;
converting the third plurality of skills into a second vector value; and
determining an angular difference between the first vector value and the second vector value.

13. The system of claim 12, wherein the processor is further programmed to map activities to skills by analyzing data using natural language processing.

14. The system of claim 12, wherein the processor is further programmed to map activities to skills by applying natural language processing to text associated with an activity.

15. The system of claim 10, wherein the processor is further programed to identify activities to improve the first plurality of skills associated with the user and output the identified skills.

16. The system of claim 10, wherein the processor is further programmed to generate a display correlating a skill with a graphical depiction of the user's mastery of the skill.

17. The system of claim 10, wherein the processor is programmed to determine a skill history by outputting a user interface that includes a text entry window configured to receive a description of an activity or experience;
receive a text entry; and
apply at least one of natural language processing or machine learning to map the text entry to the second plurality of skills.

18. The system of claim 11, wherein the processor is programmed to display a progress timeline of the second plurality of skills.

19. A system for automatically generating a career path for a user, producing a portfolio of skills corresponding to the career path, and sharing the portfolio, the system comprising:
a data store;
a display;
a user interface;
a network providing access to external resources for career data and data sharing services; and
a processor in communication with the data store, the user interface, the network, and the display, the processor programmed to:
receive data through the user input device defining a career goal of a user;
analyze the received data defining the career goal to determine at least one career option for the user;
identify at least one resource providing data about the user for accomplishing the at least one career option, and accessing the at least one resource through the network;
receive data about the user through the network identifying at least one skill applicable to the career goal and store the data in a user portfolio database; and
provide access for the user to share at least a portion of the user portfolio database through the network.

20. The system of claim 19, wherein the processor is further programmed to import data corresponding to the user through the network and map the data to identified skills.
